(19) United States
(12) Patent Application Publication
(10) Pub. No.: US 2011/0274915 A1
(43) Pub. Date: Nov. 10, 2011

(54) Recycled plastic chip panel construction

(76) Inventor: Biff Roberson, Golden, CO (US)

(21) Appl. No.: 12/799,020

(22) Filed: May 10, 2010

(51) Int. Cl. B32B 5/16; B29C 39/12

(52) U.S. Cl. 428/327; 156/246

(57) ABSTRACT

A recycled plastic chip construction panel includes a thermoplastic sheet base layer, a thermoplastic chip core layer bonded to a first thermoplastic base layer, and a thermoplastic finish layer bonded, on top of the thermoplastic chip core layer, to the thermoplastic sheet base layer and the thermoplastic chip core layer.

### CROSS REFERENCE TO RELATED APPLICATIONS

None.

### BACKGROUND OF THE INVENTION

1. Field of the Invention

The present invention relates to recycled plastic construction materials. In particular, it relates to plastic panels having a recycled plastic chip core layer for use in a wide variety of applications.

2. Description of the Related Art

Recycling plastic is a method of recovering scrap or waste plastics and reprocessing these materials into useful products, which are often times much different than the waste products in their original state. For example, plastic water bottles may be melted down and cast into other plastic structures. However, low plastic recycling rates have been largely due to the complexity and costs associated with sorting and processing, unfavorable economics, and consumer confusion about which plastics can actually be recycled.

Prior to recycling, plastics are sorted in accordance with their resin identification code. The resin identification code is a system of categorization of many different polymer types. For example, the most-often recycled plastic is high density polyethylene (HDPE), or number 2, which is down-cycled into plastic lumber, tables, roadside curbs, benches, truck cargo liners, trash receptacles, and other durable plastic products. Another such example is polyethylene terephthalate, commonly referred to as PET, which has a resin code of 1. Purified PET is often used as the raw material for a wide range of products. To obtain pure PET, the recycled items, such as plastic bottles and containers (the main use for PET), are first inspected for any non PET materials, such as paper. The non PET materials are then removed and the PET items are sorted into different color fractions, cleaned, and prepared for processing. The sorted post-consumer PET waste is crushed, chopped into flakes, pressed into bales and then offered for sale. One use for recycled PET, that has recently become popular, is to create fabrics for use in the clothing industry. The fabrics are created from PET flakes by spinning the PET flakes into a thread or yarn. The recycled PET thread or yarn can be used either alone or in combination with other fibers in order to create a very wide variety of fabrics. But, in today's new eco-friendly world, there has been more of a demand for “green” products and, as a result, many companies have started searching for new ways to take advantage of new markets and innovations in the use of recycled plastics.

Thus, it is desirable to provide a new recycled plastic chip construction panel which is partially constructed using shredded recycled waste plastic, but which is low in cost, light in weight, easily workable, waterproof, of a high strength, flexible in use, and durable in construction. Moreover, it is desirable to provide a plastic recycled chip construction panel which is amenable for use in a wide variety of applications requiring an aesthetic appearance. The present invention satisfies these needs.

### BRIEF SUMMARY OF THE INVENTION

It is therefore an object of the present invention to provide a new recycled plastic chip construction panel which is partially constructed with shredded recycled waste plastic.

It is another object of the present invention to provide a new recycled plastic chip construction panel which is partially constructed using shredded recycled waste plastic, but which is low in cost, light in weight, easily workable, waterproof, of a high strength, flexible in use, and durable in construction.

It is yet another object of the present invention to provide a new recycled plastic chip construction panel which is partially constructed using shredded recycled waste plastic and which is amenable for use in a wide variety of applications requiring an aesthetic appearance.

To overcome the problems of the prior art methods and in accordance with the purpose of the invention, as embodied and broadly described herein, briefly a recycled plastic chip panel is provided which includes a thermoplastic sheet base layer, a thermoplastic chip core layer bonded to a first thermoplastic base layer, and a thermoplastic finish layer bonded, on top of the thermoplastic chip core layer, to the thermoplastic sheet base layer and the thermoplastic chip core layer.

Additional advantages of the present invention will be set forth in part in the description that follows and in part will be obvious from that description or can be learned from practice of the invention. The advantages of the invention can be realized and obtained by the invention particularly pointed out in the appended claims.

### BRIEF DESCRIPTION OF THE SEVERAL VIEWS OF THE DRAWINGS

The accompanying drawings, which are incorporated in and which constitute a part of the specification illustrate at least one embodiment of the invention and, together with the description, explain the principles of the invention.

FIG. 1 is a top view of a corner section of the recycled plastic chip panel in accordance with the present invention showing the basic three layer construction with an additional thermoset plastic cladding layer.

FIG. 2 is a side sectional view of the construction shown in FIG. 1.

FIG. 3 is an isometric view of the construction shown in FIG. 1.

FIG. 4 is an isometric view of the panel construction in accordance with FIG. 1 showing the a thermoset layer embossed and including an aggregate composite.

FIG. 5 is a side sectional view of the construction shown in FIG. 4.

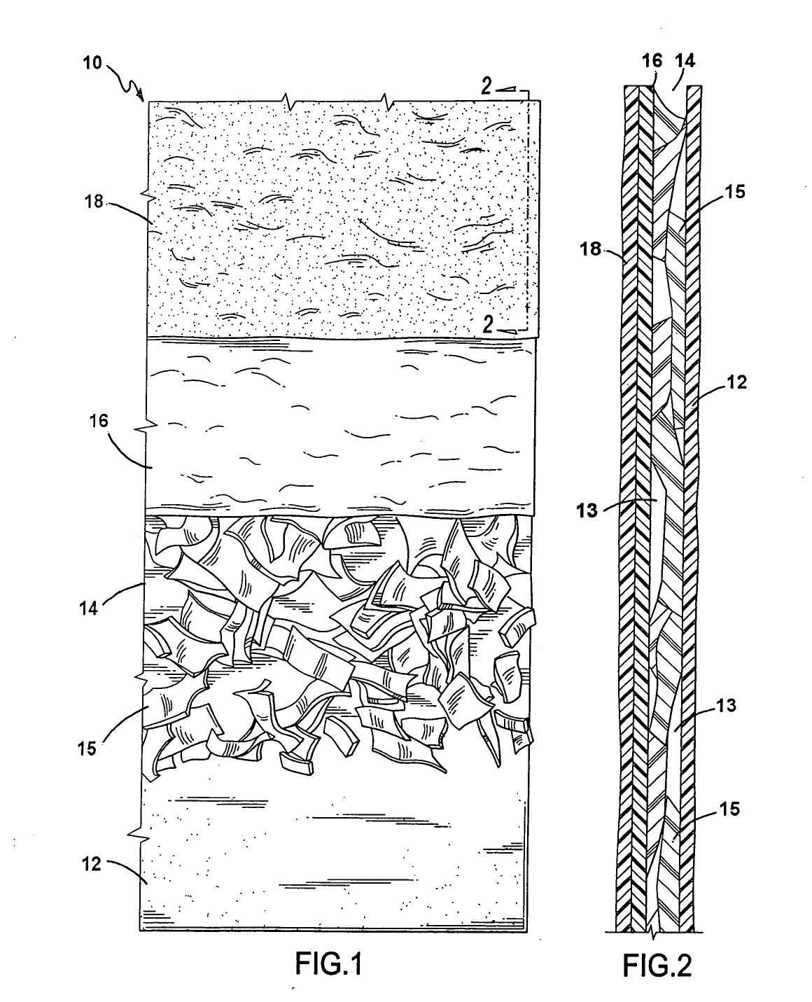

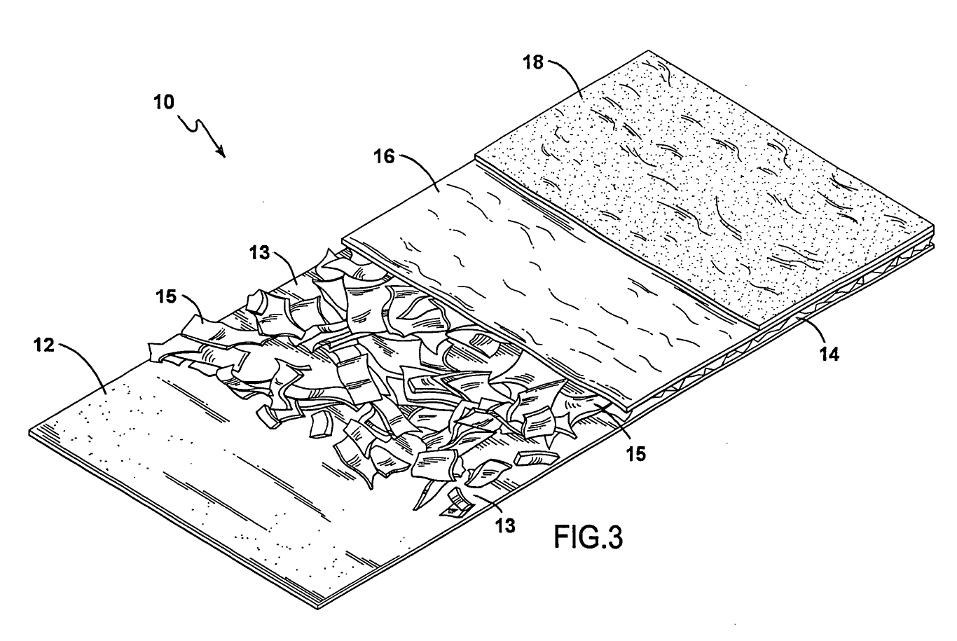

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

Generally, the panels 10, in accordance with the present invention, are made through the new use of a thermoplastic powder as a binding agent. The panels 10 are desirably constructed in a standard 121.92 cm by 243.84 cm size in any desired thickness in order to yield either a flexible or a ridged panel 10 construction depending on the desired application for use. The panels 10 are constructed of thermoplastic material which allows them to be easy to cut, drilled, and attached with any commonly used tools and fasteners. The panels 10 include a recycled plastic chip core 14. The core 14 is preferably shredded raw recycled post consumer plastic chips 15 that curl during a heat fusion process. This curling effect provides a greater degree of structural integrity, impact resistance, rigidity, and provides a dead air space or void 13 for insulation, and even buoyancy. The chips 15 are fused, but not melted, together to the inner 12 and outer 16 layers using the thermoplastic layers 12 and 16 as a binder. Virtually any plastic, in any color combination, including the paper and residual contents of a container, can be included in chip core 14 layer which thus eliminates, or shortens, the costly and time consuming sorting step currently required in the recycling process. The outer layer 16, which is intended for exposure to the elements, may, but need not, serve as a substrate for further application of a variety of finish color options either for aesthetic, or service application conditions. The finish options desirably include a thermoset powder coating 18 or a layer of a functionalized polyethylene co-polymer 19, with or without an organic or inorganic aggregate layer such as wood or a fabric, all of which are fused to the finish binder layer covering the recycled plastic chip core. With the variable thickness and finish options, the present invention provides a viable, universal building and construction material which incorporates one-hundred percent waste and remnant materials combined with the simple, but yet novel, construction satisfying the need for a low cost, easy to use, and marketable recycled plastic product.

Referring now to the drawing figures, the preferred embodiment of the present invention provides a recycled plastic chip panel 10. The panel 10 has a thermoplastic sheet base layer 12, a thermoplastic chip 15 core layer 14 bonded to a first thermoplastic layer 12, and a thermoplastic finish layer 16 bonded, on top of the thermoplastic chip 15 core layer 14, to the thermoplastic sheet base layer 12 and the thermoplastic chip 15 core layer 14. In this manner, the thermoplastic layers 12, 16 are used as a binder. In addition, a thermoset protective layer 18, or a layer of a functionalized polyethylene co-polymer 19 may, but need not, be bonded to the finish layer 16. Unlike other thermoplastic products known in the art, the panel 10 may also be deeply embossed by pressing with a tool in a predetermined design, such as a wood grain or stone block, because of the unique compressible nature inherent with the inner recycled chip 15 core layer 14. Thus, the one of the unique properties of the inner recycled chip 15 core layer 14 make the present invention particularly useful for the construction of structures having any desired abrasive or aesthetic appearance. When a layer of a functionalized polyethylene co-polymer 19 is bonded to the finish layer 16, a layer of an aggregate may also be broadcast on, and incorporated within, the polyethylene co-polymer 19, or thermoset protective layer 18, for any intended use. The present invention is also amenable for the application of a wide variety of color scheme and design sin order to further enhance the surface appearance, with techniques such as brushing or shading.

In making the plastic panel 10, in accordance with the present invention, one starts with construction of a base layer. The base layer is preferably formed on large a non-stick platen surface sufficient in size to yield a panel having an overall dimension of approximately 122 cm×244 cm. The base layer includes the thermoplastic chip 15 core layer 14 bonded to a first thermoplastic sheet 12. The first thermoplastic sheet 12 is desirably formed by coating a non-stick platen surface with approximately 2 mm of a thermoplastic powder having a particle size in the range of 10-200 mesh. The platen is heated in an oven to a temperature of approximately 204° C. for 15 minutes so that the thermoplastic powder is liquefied and flows out to a film which is approximately 2 mm thick. The platen is then allowed to cool so that the thermoplastic powder reaches its glass transition temperature so as to make the first thermoplastic sheet 12. The thermoplastic chip 15 core layer 14 is bonded to the first thermoplastic sheet 12 by broadcasting a layer of thermoplastic chips 15, such as recycled HDPE, on the first thermoplastic sheet 12. The thermoplastic sheet 12 and thermoplastic chips 15 are then heated in the oven for approximately 10 minutes, at 204° C., so that the chips 15 are fused, but not melted, to the first thermoplastic sheet 12.

The base layer may be covered with a second thermoplastic powder and remoulded to form the second thermoplastic sheet 16, or a second thermoplastic sheet 16 may be bonded directly upon the thermoplastic chip 15 core layer 14. When bonding the second thermoplastic sheet 16 to the base layer, it can be appreciated that the steps of forming the base layer and the second thermoplastic sheet 16 need not be performed in sequence. For example, one may bond the second thermoplastic sheet 16 directly on top of the chip 15 core layer 14 or inventory a variety of thermoplastic sheets for later use as either the first 12 or the second 16 thermoplastic layers depending on the desired overall process in the manufacture of the panel 10. When using a thermoplastic powder in the formation of the sheet layer 16, after removing the base layer from the oven one may introduce approximately 1 mm of the thermoplastic powder, desirably having a particle size in the range of 10-200 mesh, on top of the chip layer 14 and then reheat the platen in the oven to a temperature of approximately 204° C., for 10 minutes, so that the thermoplastic powder is liquefied and flows out to a film which is approximately 2 mm thick. After cooling, to its glass transition temperature, this product may constitute the finished product for marketing to others depending upon the desired use. In the second instance, one may separately form a second thermoplastic sheet finish layer 16 on a non-stick platen surface which is also sized to yield a panel having an overall dimension of approximately 122 cm×244 cm. In this manner, the second thermoplastic sheet 16 is formed by coating the non-stick platen surface with approximately 2 mm of a thermoplastic powder having a particle size in the range of 10-200 mesh. This platen is then heated in an oven to a temperature of approximately 204° C., for 15 minutes, until the thermoplastic powder is liquefied and flows out to a film which is approximately 2 mm thick. The platen is then allowed to cool, so that the thermoplastic powder reaches its glass transition temperature. The second thermoplastic sheet finish layer 16 is then bonded to the base layer by covering the chip layer 14, of the base layer, with the second thermoplastic sheet finish layer 16 and re-heating the base layer and the second thermoplastic sheet finish layer 16 for approximately 10 minutes, at 204° C., so that the second thermoplastic sheet 16 and the base layer are fused. After cooling, so that the base layer and finish layer 16 reach a glass transition temperature, a finished product is, once again, ready for the market if it is consistent with its intended use. In the preferred embodiments the thermoplastic powder is polyethylene and the thermoplastic chips are of an irregular shape having a size in the range of 3.2 mm to 25.4 mm. Also, while best described above, heating the thermoplastic chip 15 core layer 14 in order to bond it to the first thermoplastic sheet layer 12 is desirably controlled in a temperature range of 204° C.-232° C. dependant upon the thermoplastic formulation, density and desired thickness of the panel 10 to be produced.

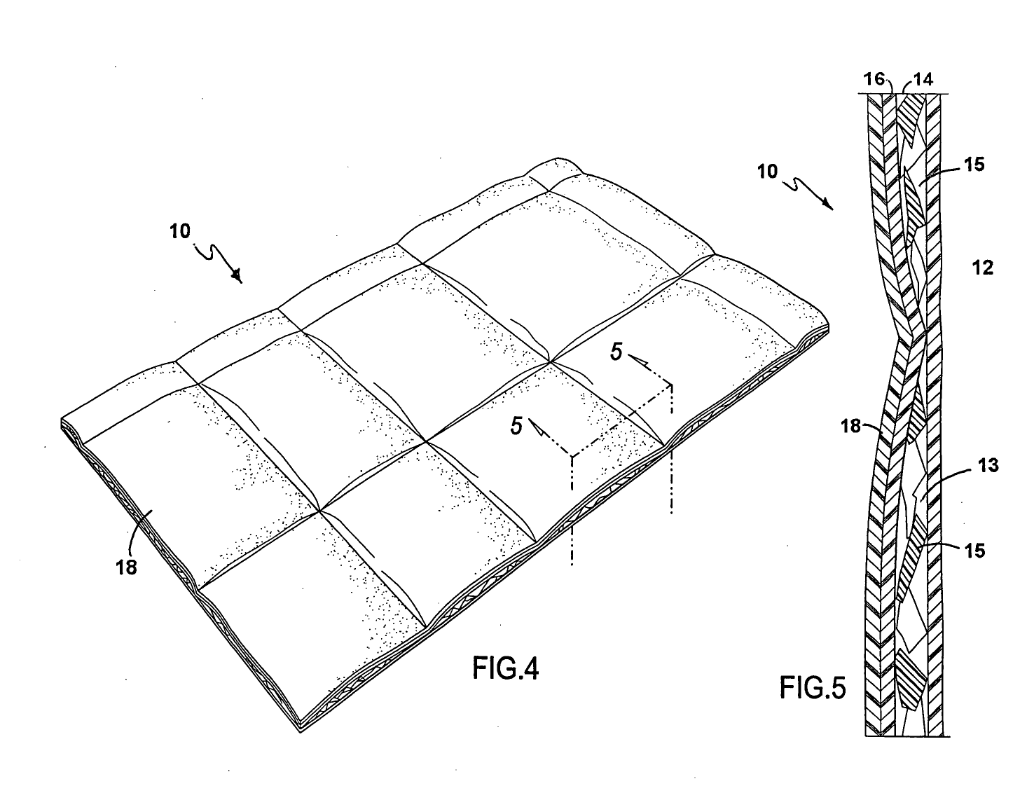

The plastic panel 10 formed in accordance with the above mentioned method may also include a cladding layer preferably formed of either a thermoset plastic powder coating 18 or thermoplastic layer, such as functionalized polyethylene co-polymer, in the range of 16-150 mesh, by broadcasting and heating the panel 10 and cladding layers to a temperature in the range of 204° C.-232° C. The cladding layer is advantageous in providing a decorative or protective finish, including ultra-violet light protection. In addition, when using a polyethylene co-polymer material as an interface coat, one may also broadcast an aggregate (illustrated as dots on the surface in FIG. 4) or wood veneer into the interface coat 19 in an amount and configuration which is dependent, once again, on the intended use.

The present invention provides for adhering the thermoset layer 18 to the panel 10 by taking advantage of the adhesion properties of the thermoplastic polyethylene co-polymer material layer. With this example, the top thermoset layer 18 is fused to the polyethylene co polymer interface which acts as an adhesive for thermally bonding the thermoset layer 18 to the panel 10. Even further processing of the resulting thermoset layer 18 surface may, but need not, include embossing the surface, while at a temperature above the glass transition temperature, with a tool, to a predetermined pattern, so as to give the appearance of the stone or brick pattern shown in FIG. 4. In addition, the pattern may be further highlighted in a contrasting color for enhancing a three-dimensional effect, by dusted the thermoset layer 18 with a thermoset powder contrasting color, then removing a predetermined portion of the contrasting color powder, so as to create the desired highlight effect, and then curing the contrasting color for approximately 10 minutes, at 204° C.

While the present invention has been described in connection with the embodiments as described and illustrated above, it will be appreciated and understood by one of ordinary skill in the art that certain modifications may be made without departing from the true spirit and scope of the invention, as described and claimed herein. Specifically, pertinent to the process for making the panel 10 in accordance with the present invention the only steps that need be performed in sequence are the steps of bonding the second thermoplastic layer 16 to the base layer, and the step of fusing of the recycled chip 15 layer 14 to the first thermoplastic layer 12.

I claim:

1. A recycled plastic chip panel, comprising:
(a) a thermoplastic sheet base layer;
(b) a thermoplastic chip core layer bonded to a first thermoplastic sheet base layer;
(c) a thermoplastic finish layer bonded, on top of the thermoplastic chip core layer, to the thermoplastic sheet base layer and the thermoplastic chip core layer.

2. The recycled plastic chip panel according to claim 1, further comprising a thermoset layer bonded to the finish layer.

3. The recycled plastic chip panel according to claim 1, further comprising a layer of a functionalized polyethylene co-polymer bonded to the finish layer.

4. The recycled plastic chip panel according to claim 2, wherein the thermoset protective layer is embossed.

5. The recycled plastic chip panel according to claim 3, further comprising a layer of an aggregate broadcast to the polyethylene co-polymer.

6. A plastic panel formed by a process, comprising the steps of:
(a) forming a base layer on a non-stick platen surface, the base layer including a thermoplastic chip core layer bonded to a first thermoplastic sheet, said first thermoplastic sheet formed by coating the non-stick platen surface with a thermoplastic powder, heating the platen so that the thermoplastic powder is liquefied, and then cooling the platen so that the thermoplastic powder reaches a glass transition temperature, said thermoplastic chip core layer bonded to the first thermoplastic sheet by broadcasting a layer of thermoplastic chips on the first thermoplastic sheet, and heating the thermoplastic sheet and thermoplastic chips so that the thermoplastic chips fuse to the first thermoplastic sheet; and
(b) bonding a thermoplastic finish layer to the base layer by covering the thermoplastic chip core layer of the base layer with a second thermoplastic material, re-heating the base layer and the second thermoplastic material, and cooling so that the base and finish layers reach a glass transition temperature.

7. The plastic panel formed by a process according to claim 6, wherein the thermoplastic material is polyethylene.

8. The plastic panel formed by a process according to claim 6, wherein the thermoplastic chips are an irregular shape having a size in a range of 3.2 mm to 25.4 mm.

9. The plastic panel formed by a process according to claim 6, further comprising the step of bonding a thermoset plastic layer to the finish layer.

10. The plastic panel formed by a process according to claim 6, further comprising the step of bonding a layer of a functionalized polyethylene co-polymer to the finish layer.

11. The plastic panel formed by a process according to claim 6, wherein the second thermoplastic material is a powder.

12. The plastic panel formed by the process according to claim 6, wherein the second thermoplastic material is a sheet.

13. The plastic panel formed by a process according to claim, 7 wherein the polyethylene is a powder in a size range of 16-150 mesh, and heating the powder is in a temperature range of 204° C.-232° C.

14. The plastic panel formed by a process according to claim 8, wherein said thermoplastic chip core layer is bonded to the first thermoplastic sheet by heating in a range of 204° C.-232° C.

15. The plastic panel formed by a process according to claim 9, further comprising the step of embossing the thermoset plastic layer.

16. The plastic panel formed by a process according to claim 10, further comprising the step of bonding an aggregate to the polyethylene co-polymer.
